(19) United States
(12) Patent Application Publication
(10) Pub. No.: US 2025/0033981 A1
(43) Pub. Date: Jan. 30, 2025

(54) MESOPOROUS SILICA CONTAINING ZINC OXIDE AND MANUFACTURING METHOD THEREOF

(71) Applicant: CEN CO., LTD., Busan (KR)

(72) Inventor: Sang Cheol HAN, Busan (KR)

(21) Appl. No.: 18/708,850

(22) PCT Filed: May 15, 2023
(86) PCT No.: PCT/KR2023/006570

§ 371 Date: May 9, 2024

(30) Foreign Application Priority Data
May 16, 2022 (KR) 10-2022-0059769

(51) Int. Cl. C01B 33/18

(52) U.S. Cl. CPC C01B 33/18; C01P 2004/03; C01P 2006/12

(57) ABSTRACT

Mesoporous silica containing zinc oxide and a production method therefor are described. In the mesoporous silica containing zinc oxide, which is spherical mesoporous silica, an inside of the mesoporous silica contains a plurality of mesopores, zinc ions are bound to the mesopores to form zincosilicate, and zinc oxide is bound to the zincosilicate. According to an embodiment, it is possible to provide mesoporous silica having a large specific surface area and pore volume and to improve economic efficiency and production yield by simplifying the production process.

### TECHNICAL FIELD

The present invention relates to mesoporous silica containing zinc oxide and a production method therefor, and specifically, to mesoporous silica wherein a plurality of mesopores are formed in perfectly spherical silica and zinc oxide is bound to the inside of the mesopore, and a production method therefor.

### BACKGROUND ART

In general, a method for synthesis of mesoporous silica has mainly been a synthesis method using a surfactant. Depending on the method of interaction between the surfactant and silica, an important factor for synthesis is pH adjustment to acidic, basic, or neutral conditions.

SBA-based mesoporous silicas, synthesized under acidic conditions, have excellent thermal stability compared to other mesoporous silicas, and thus are widely used in catalytic reactions. Thereamong, SBA-16 mesoporous silica, synthesized using F127, has 3D porous channels, which facilitate the entry and exit of material, and many studies have been conducted to use the same as catalysts. In particular, aluminum-substituted mesoporous silica shows Lewis acidity and may be used in Lewis acid catalysis reactions.

Unlike zeolite having micropores, mesoporous silica does not contain aluminum, and thus has little or no catalyst active sites. Accordingly, active sites need to be introduced in order to use mesoporous silica as a catalyst. Although many studies have been conducted to introduce active sites into mesoporous silica, it is difficult to achieve a method of synthesizing mesoporous silica by introducing a metal directly during the synthesis process, because the synthesis is carried out under acidic conditions and the introduced metal exists in an ionic state.

Conventionally known mesoporous silica has a popcorn shape rather than a perfectly spherical form, and has a problem in that the efficiency thereof in the fields of application of mesoporous silica is low due to its small specific surface area and pore volume.

In addition, the conventional method of producing mesoporous silica has been performed under acidic or basic conditions as described above.

At this time, regarding the acidic or basic conditions, the reaction for production proceeds under strongly acidic or strongly basic conditions which are a harsh environment, and thus environmental pollution problems due to the production environment may arise.

Likewise, even under such strongly acidic or strongly basic conditions, a problem arises in that it is possible to produce mesoporous silica only when the reaction is carried out under high-temperature conditions.

Due to these difficulties in the production process, problems arise in that the production cost is very high and in that the production yield is low even though mesoporous silica is produced under harsh conditions.

Unlike zeolite having micropores, mesoporous silica does not contain aluminum, and thus has little or no catalyst active sites. Accordingly, active sites need to be introduced in order to use mesoporous silica as a catalyst. Although many studies have been conducted to introduce active sites into mesoporous silica, it is difficult to achieve a method of synthesizing mesoporous silica by introducing a metal directly during the synthesis process, because the synthesis is carried out under acidic conditions and the introduced metal exists in an ionic state.

Although methods for introducing metal into mesoporous materials have been studied so far, a method of introducing metal after synthesizing mesoporous silica has been used, due to the difficulty of direct synthesis. This post-treatment method results in reduction in the reusability of the catalyst because the metal is detached from the catalyst during the reuse of the catalyst. Although metal nanoparticles have been recently applied to various industrial fields due to their catalytic characteristics and efficacies such as sterilizing activity and deodorizing activity, there have been reports on problems in that nanoparticle materials are absorbed in vivo through skin tissue or the respiratory system, causing harm to the human body. Thus, there are questions about the safety of the use of nanoparticle materials.

In order to overcome these problems, it is needed to develop mesoporous silica which has a large specific surface area and pore volume so as to be capable of exhibiting excellent effects when applied to the fields of application of mesoporous silica, and also has improved economic efficiency and production conditions, and in which metal nanoparticles are bound to the inside of mesopores.

### PRIOR ART DOCUMENTS

### Patent Documents

(Patent Document 1) KR 10-2007-0068871 A1

### DISCLOSURE

### Technical Problem

An object of the present invention is directed to mesoporous silica containing zinc oxide and a production method therefor.

Another object of the present invention is to provide mesoporous silica having a large specific surface area by having a plurality of mesopores formed therein and fine grooves, derived from the mesopores, formed on the surface thereof, wherein zinc ions are bound to the internal mesopores to form zincosilicate, zinc oxide (ZnO) is bound to the zincosilicate, and the mesoporous silica has excellent adsorption effects and excellent effects of adsorbing and decomposing external contaminant particles, etc.

Still another object of the present invention is to provide mesoporous silica with an excellent water repellent effect wherein a hydrophobic side chain is bound to mesopores of the mesoporous silica, and the hydrophobic side chain protrudes to the outside so as to be capable of exhibiting hydrophobic properties.

Yet another object of the present invention is to provide a method for producing mesoporous silica containing zinc oxide, which simplifies the production process, does not use toxic materials such as strong acids and strong bases in the production process, and has high economic efficiency and high production yield.

### Technical Solution

To achieve the above objects, mesoporous silica containing zinc oxide according to one embodiment of the present invention is spherical mesoporous silica, wherein the inside of the mesoporous silica contains a plurality of mesopores, zinc ions are bound to the mesopores to form zincosilicate, and zinc oxide is bound to the zincosilicate.

Fine grooves derived from the internal mesopores are formed on the surface of the mesoporous silica.

The zinc oxide is bound to a ligand compound containing a hydrophobic side chain, and the hydrophobic side chain of the ligand compound protrudes to the outside of the mesoporous silica. The spherical mesoporous silica has a specific surface area of 900 to 2,000 m²/g. A method for producing mesoporous silica containing zinc oxide according to another embodiment of the present invention includes steps of: 1) adding an alkylamine to a solvent, followed by stirring; 2) preparing a metal ion solution by dissolving a metal compound in the solution containing the alkylamine uniformly dispersed therein; 3) preparing silica-coated complex micelles by adding a silica precursor to the metal ion solution, followed by stirring; 4) producing mesoporous silica by subjecting the silica-coated complex micelles to reduction with a reducing agent; and 5) calcining the mesoporous silica at 500 to 600° C.

The metal compound may be selected from the group consisting of Zn(NO₃)₂, ZnCl₂, ZnSO₄, Zn(OAc)₂, and mixtures thereof.

The method for producing mesoporous silica containing zinc oxide according to the other embodiment of the present invention may further include a step of allowing a ligand compound containing a hydrophobic side chain to react with the mesoporous silica resulting from the calcining step.

Hereinafter, the present invention will be described in more detail.

Mesoporous silica containing zinc oxide according to one embodiment of the present invention is spherical mesoporous silica, wherein the inside of the mesoporous silica contains a plurality of mesopores, zinc ions (Zn²⁺) are bound to the mesopores to form zincosilicate, and zinc oxide is bound to the zincosilicate.

The mesoporous silica generally refers to silica having a pore size of 2 to 50 nm.

However, the mesoporous silica of the present invention is perfectly spherical mesoporous silica, and may be produced in the form shown in FIG. 1.

In addition, a plurality of mesopores are formed in the mesoporous silica, and the mesopores are connected to each other and are formed to extend to the surface. In addition, the surface is characterized in that fine grooves are formed thereon by the mesopores.

Although the mesoporous silica has a perfectly spherical shape, a plurality of fine grooves are formed on the surface, and thus the mesoporous silica may exhibit a larger specific surface area than one with a smooth surface.

Conventional mesoporous silica has a popcorn shape rather than a perfectly spherical shape, is composed of an aggregate of a silica precursor, and thus does not have a perfectly spherical shape.

Due to this difference in shape, the mesoporous silica of the present invention exhibits large specific surface area and pore volume characteristics, whereas conventional mesoporous silica exhibits relatively small specific surface area and pore volume.

In other words, mesoporous silica is a mesoporous material in which mesopores with uniform pore diameters are arranged regularly. This mesoporous material has a large specific surface area and chemical and thermal stability, and porous molecular sieve materials are capable of selectively separating and adsorbing materials at the molecular level because uniformly sized micropores are arranged regularly therein. In addition, because these molecular sieve materials have the great advantage of being able to control molecules within the pores, they may be widely used as catalysts in chemical reactions and as catalyst carriers.

The specific surface area is the value obtained by dividing the surface area of the material by the weight, and corresponds to a very important value in interfacial phenomena. A larger specific surface area value indicates a larger surface area per weight.

The larger the surface area, the greater the area of contact with the component to be adsorbed by the mesoporous silica.

In addition, the pore volume refers to the volume of the entire pores inside the mesoporous silica, and the larger the pore volume, the greater the amount of the component adsorbed in the mesopores.

The larger the specific surface area and pore volume values, the greater the amount of the component adsorbed in the mesoporous silica when using the same mesoporous silica, indicating that even when the mesoporous silica is used in a smaller amount, it may exhibit a better effect.

The mesoporous silica of the present invention according to FIG. 1 has a specific surface area of 900 to 2,000 m²/g, preferably 950 to 1,500 m²/g, but the specific surface area is not limited to the above example and may be adjusted depending on the type of use.

The average diameter of the pores in the mesoporous silica of the present invention according to FIG. 1 is 3 to 5 nm, but may be adjusted depending on the type of use.

In addition, in terms of the total volume of pores, the spherical mesoporous silica of the present invention has a large pore volume of 1 to 2 cm³/g.

In addition, the mesoporous silica may be formed to have an average diameter of 200 to 280 nm and a particle size distribution of 100 to 550 nm. The mesoporous silica may have a very large specific surface area vs. average diameter and also have a large pore diameter and pore volume. As described above, the mesoporous silica of the present invention shows significant differences in specific surface area, average pore diameter, and pore volume from conventional mesoporous silica. Due to these differences, even if the mesoporous silica of the present invention is used in the same amount as that of conventional mesoporous silica, it shows a large difference in the area where reaction by contact can occur, due to differences in specific surface area, average pore diameter, and pore volume.

As described later, in order to produce the mesoporous silica of the present invention, an alkylamine is added to a solvent, followed by stirring. Then, a metal compound is dissolved in the solution containing the alkylamine uniformly dispersed, thereby preparing a metal ion solution. The metal ions are zinc ions, and mesoporous silica is produced by adding a silica precursor to the solution containing the zinc ions and performing stirring and reduction. At this time, the zinc ions are bound to silica to form zincosilicate.

The zincosilicate includes a bonding structure represented by Formula 1 below:

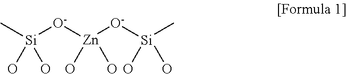

In the above-described zincosilicate, as shown in Formula 1 above, the oxygen atoms bound to Zn exhibit negative properties, a zinc ion (Zn²⁺) is bound to the oxygen atoms, and the bound zinc ion may be oxidized into zinc oxide.

As zinc oxide is bound to the inside of the mesoporous silica, not only the effect due to the mesoporous silica but also the effect due to the bound zinc oxide may be exhibited.

The mesoporous silica of the present invention has a perfectly spherical shape, and as it has a large specific surface area and pore volume, the amount of zinc oxide bound thereto increases, and thus the mesoporous silica may be used as a catalyst or exhibit the effect of zinc oxide.

In general, zinc oxide is known to have optical properties, thermal properties, electronic properties, etc.

More specifically, zinc oxide has a high blocking power against ultraviolet rays due to its optical properties, may be used as a transparent pigment, and exhibits the property of being poorly soluble in common solvents such as water and oil.

Based on these properties, zinc oxide may be added to paint, rubber, and plastic materials that need to be protected against UV rays, increasing resistance to UV rays, and may also be used as a sunscreen.

When zinc oxide is used as a sunscreen as described above, it can exhibit highly efficient UV blocking effects, whitening effects, and anti-aging effects.

In addition, zinc oxide may be used to absorb ultraviolet rays in photosensitive paper, photoelectric cells, etc., and thus it has very high potential for use as a photocatalyst.

Due to the above-described thermal properties, zinc oxide has high heat capacity and excellent heat conduction quality. Due to these effects, zinc oxide may be mixed with ingredients such as rubber and glass to improve thermal durability, and may be used as a tire additive to prevent degradation and wear.

In addition, even when the mesoporous silica containing zinc oxide according to the present invention is mixed with ceramics and used, it can serve to improve heat resistance and wear resistance.

Due to the above electrical and electronic properties, zinc oxide may be used as a semiconductor and also as an insulator.

In general, pure zinc oxide is composed of a combination of zinc ions and oxygen ions and exhibits insulator properties, but when it is heat treated or a material is added to the crystal lattice of zinc oxide, it may be used as a semiconductor with excellent electrical conductivity.

Additionally, due to its basic insulating properties, zinc oxide may also be used as a varistor and thermistor.

Lastly, zinc oxide is an essential nutrient for the human body and may also be used as a nutritional supplement or livestock feed.

In addition, mesoporous silica containing zinc oxide according to another embodiment of the present invention may be combined with a ligand compound containing a hydrophobic side chain. The ligand compound contains a hydrophobic side chain, and the ligand compound may be bound to the zinc oxide of the mesoporous silica. When the ligand compound is bound to the zinc oxide as described above, the hydrophobic side chain in the ligand compound protrudes to the outside of the mesoporous silica.

As the hydrophobic side chain protrudes to the outside, the mesoporous silica of the present invention can exhibit excellent water-repellent properties.

The ligand compound may be selected from the group consisting of stearic acid, lauroyl acid, lauric acid, laurylamine, hexadecylamine, perfluorooctylamine, perfluorooctanoic acid, 2-perfluorohexyl ethyl thiol, 9-octadecen-1-amine, 5-phenyl-1-pentanamine, dodecanol, and mixtures thereof, but is not limited to the above examples, and any compound, which may be bound to zinc oxide and may contain an alkyl group having 10 or more carbon atoms as a substituent, may be used without limitation.

As described above, the ligand compound contains an alkyl group having 10 or more carbon atoms and exhibits the property of being able to bind to zinc oxide. The alkyl group is a long chain containing 8 or more carbon atoms, and even when the ligand compound is bound to zinc oxide bound to the inside of the mesoporous silica, it protrudes to the outside and can exhibit water-repellent properties.

In addition, in the method for producing mesoporous silica described later, according to the present invention, it is possible to improve the production environment by producing mesoporous silica under production conditions that are not harsh acidic or basic conditions, and also it is possible to improve the production yield by using a simple production method.

A method for producing spherical mesoporous silica according to another embodiment of the present invention includes steps of: 1) adding an alkylamine to a solvent, followed by stirring; 2) preparing a metal ion solution by dissolving a metal compound in the solution containing the alkylamine uniformly dispersed therein; 3) preparing silica-coated complex micelles by adding a silica precursor to the metal ion solution, followed by stirring; 4) producing mesoporous silica by subjecting the silica-coated complex micelles to reduction with a reducing agent; and 5) calcining the mesoporous silica at 500 to 600° C.

More specifically, the alkylamine may be an amine-based template, and specifically is an alkylamine having an alkyl group having 8 to 16 carbon atoms. More specifically, the alkylamine is selected from the group consisting of dodecylamine, decylamine, tetradecylamine, and mixtures thereof, but is not limited to the above examples.

The solvent is more specifically an aqueous alcohol solution, wherein the alcohol is selected from the group consisting of methyl alcohol, ethyl alcohol, propyl alcohol, butanol, and pentanol, and is preferably ethyl alcohol, but is not limited to the above examples and any alcohol may be used without limitation.

The aqueous alcohol solution is a mixture of 5 to 15 wt % of alcohol and 85 to 95 wt % of purified water. If the alcohol is contained in an amount of less than 5 wt %, a problem may arise in that the alkylamine is not sufficiently dissolved because the amount of alcohol used is insufficient, and if the alcohol is contained in an amount of more than 10 wt %, the alkylamine will be diluted with the alcohol, resulting in a decrease in the overall reaction rate.

To prepare the solution, the gel forming agent is added to the solvent, followed by stirring at 50 to 70° C. for 30 to 90 minutes until the solution becomes transparent. Preferably, the solution is stirred vigorously at 60±1° C. for 60 minutes and stirred at 15 to 25° C. for about 1 hour.

Through the stirring process, micelles composed of the alkylamine are formed in the solution. The solution is prepared by adding 15 to 25 ml of water and 1 to 5 ml of alcohol per mmol of the alkylamine. If the amount of the aqueous alcohol solution added is smaller than the lower limit of the above range, a problem may arise in that the reaction does not occur because the alkylamine is not easily dissolved, and if the amount of the aqueous alcohol solution added is larger than the upper limit of the above range, a problem may arise in that the yield is lowered. Step 2) is a step of preparing a metal ion solution by dissolving a metal compound in the solution containing the alkylamine uniformly dispersed therein.

More specifically, the metal compound is added to the solution and the mixture is stirred for 30 to 90 minutes so that the metal ions are uniformly dispersed in the solution containing the alkylamine dissolved therein. Preferably, stirring with a magnetic bar may be performed for 60 minutes, thereby preparing a solution containing metal ions uniformly dispersed therein.

The metal compound may be selected from the group consisting of Zn(NO₃)₂, ZnCl₂, ZnSO₄, and Zn(OAc)₂, but is not limited to the above examples.

A complex compound may be obtained by adding metal ions to the solution containing the alkylamine dissolved therein, followed by stirring. The complex compound is a form in which metal ions are bound to the micelles formed of the alkylamine. The amount of the metal ions added is preferably 4 to 5 ml of a 1 mmol metal ion aqueous solution per 1 mmol of the alkylamine, but it is not limited to the above example and may be any amount within the range in which the complex compound may be produced.

Thereafter, a silica precursor is added thereto, followed by vigorous stirring. When the silica precursor is added, followed by stirring, the silica precursor becomes trapped inside the complex compound formed of the alkylamine-metal ion. That is, the complex compound is in the form of a micelle in which the alkyl group of the alkylamine is located inside and the amine group is located outside, and the silica precursor, which is hydrophobic, together with the alkyl group, becomes trapped inside the micelle. Thereafter, through a continuous stirring process, the silica precursor undergoes a hydrolysis reaction, and through the hydrolysis, a silica-coated complex compound formed of the alkylamine-metal ion is formed.

The silica precursor may be selected from the group consisting of tetraethoxyorthosilicate (TEOS), tetramethoxyorthosilicate (TMOS), tetra(methylethylketoxime) silane, vinyl oxime silane (VOS), phenyl tris(butanone oxime) silane (POS), methyltriethoxysilane (MTES), methyltrimethoxysilane (MTMS), and mixtures thereof, and is preferably tetraethoxyorthosilicate (TEOS), but is not limited to the above examples and any silica precursor may be used without limitation.

The silica precursor may be added in an amount ranging from 4 to 10 mmol per mmol of the alkylamine, but is not limited to the above range and may be added in any amount as long as spherical mesoporous silica can be formed. If the amount of the silica precursor added is less than 4 mmol, a problem may arise in that the silica layer thickness becomes excessively thin, thus impairing the stability of the structure, and if the amount of the silica precursor added is more than 10 mmol, the silica outer wall thickness becomes excessively thick and other structures may be formed.

After the silica-coated complex compound is produced, a reducing agent is added thereto and a reduction process is performed.

The reducing agent is selected from the group consisting of trisodium citrate, NaBH₄, phenylhydrazine. HCl, ascorbic acid, phenylhydrazine, LiAlH₄, N₂H₄, and hydrazine, and is preferably NaBH₄, but is not limited to the above examples and any reducing agent may be used without limitation.

As the reduction process is performed, production into mesoporous silica proceeds, and at this time, hydrogen gas is generated inside the mesoporous silica and discharged. As hydrogen gas is generated and discharged as described above, a plurality of mesopores are formed inside, porous silica is produced in which the mesopores are connected to each other. The porous silica is characterized in that fine grooves derived from mesopores are formed thereon.

The reducing agent may be added in an amount of 0.2 to 0.6 mol per mol of the alkylamine, but is not limited to the above range and any amount may be used without limitation. If the amount of the reducing agent added is less than 0.2 mol, the production of mesoporous silica will not be smooth, and if the amount of the reducing agent added exceeds 0.6 mol, it will have no effect on the production yield of mesoporous silica, and an excessive amount of the reducing agent may remain in the solution.

Next, a step of calcining the mesoporous silica at 500 to 600° C. is performed, thereby producing mesoporous silica containing zinc oxide.

Thereafter, washing and drying processes are performed, thereby producing spherical mesoporous silica in which the metal is incorporated in the mesopores.

Specifically, the calcining step is performed at 550° C. for 5 to 7 hours, thereby producing mesoporous silica in which zinc oxide is bound to the mesopores.

Through the calcining step, mesoporous silica in which zinc oxide is bound to the internal mesopores can be produced. The produced mesoporous silica is characterized in that zincosilicate resulting from the binding of zinc ions is formed therein.

Mesoporous silica in which a hydrophobic side chain protrudes to the outside, according to another embodiment of the present invention, may be produced by the following production method.

The mesoporous silica resulting from the calcining step is added to and dispersed in a solvent, and then a solution containing a ligand compound dissolved therein is mixed with the solution containing the mesoporous silica dispersed therein, and then the mixture is stirred, separated, and washed. Next, the washed material may be dried in an oven at 60 to 100° C. for 10 to 15 hours, thereby producing mesoporous silica in which a hydrophobic side chain protrudes to the outside. Through the above process, it is possible to produce mesoporous silica wherein a ligand compound is bound to zinc oxide bound to the inside of the mesoporous silica and a hydrophobic side chain of the ligand compound protrudes to the outside.

The ligand compound may be selected from the group consisting of laurylamine, stearic acid, and mixtures thereof, but is not limited to the above examples and it is possible to use, without limitation, any compound containing a hydrophobic side chain which may be bound to zinc oxide bound to the inside of the mesoporous silica and protrude to the outside through the mesopores.

### Advantageous Effects

According to the zinc oxide-bound mesoporous silica and the method for producing the same according to the present invention, it is possible to provide mesoporous silica with a large specific surface area and pore volume, and improve economic efficiency and production yield by simplifying the production process.

In addition, the mesoporous silica has an excellent adsorption effect, is capable of exhibiting the antimicrobial effect and photodecomposition effect of zinc oxide due to zinc oxide bound to the inside of the mesopores, and is capable of exhibiting water-repellent properties when combined with a ligand compound.

### BRIEF DESCRIPTION OF DRAWINGS

FIG. 1 is a SEM photograph of mesoporous silica according to an embodiment of the present invention.

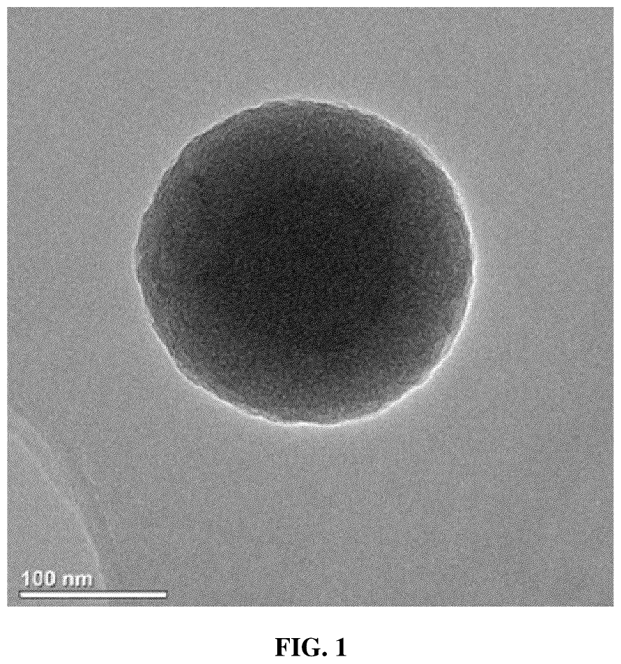

FIG. 2 depicts photographs showing the results of component analysis of zinc oxide-bound mesoporous silica according to an embodiment of the present invention.

FIG. 3 shows the results of analyzing the particle diameter of zinc oxide-bound mesoporous silica according to an embodiment of the present invention.

FIG. 4 shows the results of evaluating the MB absorption effect of zinc oxide-bound mesoporous silica according to an embodiment of the present invention.

FIG. 5 shows the results of an experiment on the water repellent effect of mesoporous silica according to an embodiment of the present invention.

FIG. 6 shows the results of an experiment on the hydrophobic and hydrophilic properties of mesoporous silica according to an embodiment of the present invention.

FIG. 7 shows the results of an experiment on the water repellent effect of mesoporous silica according to an embodiment of the present invention.

FIG. 8 shows the results of an experiment on the hydrophobic and hydrophilic properties of mesoporous silica according to an embodiment of the present invention.

### BEST MODE

The present invention is directed to mesoporous silica containing zinc oxide, which is spherical mesoporous silica, wherein the inside of the mesoporous silica contains a plurality of mesopores, zinc ions are bound to the mesopores to form zincosilicate, and zinc oxide is bound to the zincosilicate.

### MODE FOR INVENTION

Hereinafter, examples of the present invention will be described in detail so that the present invention can be easily carried out by those skilled in the art. However, the present invention may be embodied in many different forms and is not limited to the examples described herein.

### Production Example 1: Production of Spherical Mesoporous Silica

1 mmol of dodecylamine (DDA) was added to 20 mL of a 10% aqueous solution of ethyl alcohol, followed by stirring at a temperature of 60±1° C. for 1 hour until the aqueous ethyl alcohol solution became transparent. Next, the solution was kept with stirring at room temperature for about 1 hour.

Thereafter, 5 ml of an aqueous solution containing metal ions as shown in Table 1 below was added thereto, followed by stirring with a magnetic bar for about 1 hour. 4 mmol of tetraethoxyorthosilicate (TEOS), a silica precursor, was added to the solution to which the metal ions have been additionally added, followed by vigorous stirring at room temperature (20 to 25° C.) for 1 hour.

Thereafter, 0.2 mmol of NaBH₄, a reducing agent, was added to the stirred solution to obtain spherical mesoporous silica, which was then vacuum-filtered at a pressure of 30 mmHg. Next, the filtered spherical mesoporous silica was washed three times with 200 ml of distilled water and washed three times with 100 ml of ethyl alcohol at 60° C.

After completion of the washing process, the mesoporous silica was dried at a temperature of 70° C. for 2 hours and calcined at 550° C. for 6 hours, thereby producing mesoporous silica containing zinc oxide bound to the inside of the mesopores.

TABLE 1

| | | Content (molar concentration) |
|---|---|---|
| | First metal compound | in aqueous solution |
| Example 1 | Zn(NO₃)₂ | 0.1 |
| Example 2 | ZnCl₂ | 0.1 |
| Example 3 | ZnSO₄ | 0.1 |
| Example 4 | Zn(OAc)₂ | 0.1 |

### Experimental Example 1

Checking of Formation of Spherical Mesoporous Silica Particles Whether spherical mesoporous silica was formed was checked depending on the type of metal compound in Examples 1 to 4.

Whether spherical mesoporous silica was produced in a perfectly spherical shape was examined by SEM imaging. The results are shown in Table 2 below.

TABLE 2

| | Particle formation |
|---|---|
| Example 1 | ∘ |
| Example 2 | ∘ |
| Example 3 | ∘ |
| Example 4 | ∘ |

As shown in Table 2 above, it was confirmed that uniform spherical mesoporous silica was produced regardless of the type of metal compound.

### Experimental Example 2

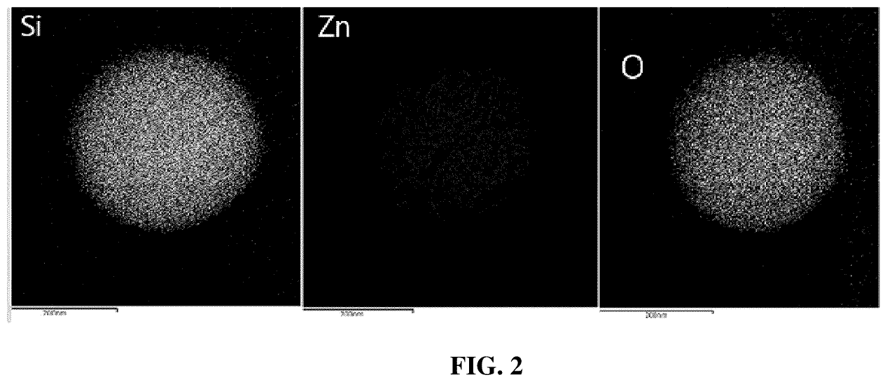

Component Analysis of Spherical Mesoporous Silica 5 The component analysis results for the spherical mesoporous silicas produced using the metal compounds in Examples 1 to 4 are shown in FIG. 2 and are more specifically shown in Table 3 below.

TABLE 3

| Element | Weight (%) | Atomic (%) |
|---|---|---|
| O K | 53.24 | 68.04 |
| Si K | 41.76 | 30.40 |
| Zn K | 4.99 | 1.56 |
| Total | 100 | 100 |

Referring to FIG. 2 and Table 3, it can be seen that the spherical mesoporous silica of the present invention is composed of Si, Zn, and O. Referring to FIG. 2, it can be seen that Zn, Si, and O are distributed very uniformly. That is, in order to produce the spherical mesoporous silica of the present invention, the silica precursor was added to the solution containing zinc ions dissolved therein, followed by stirring and reduction, thereby producing mesoporous silica. Zincosilicate is formed inside the mesoporous silica by the binding of zinc ions, and zinc ions are bound to the zincosilicate. When the produced mesoporous silica is calcined after drying, the zinc bound to the inside of the mesopores is oxidized, thereby producing mesoporous silica containing zinc oxide thereto.

### Experimental Example 3

### Particle Analysis of Spherical Mesoporous Silica

The specific surface area, pore volume, and pore size of the mesoporous silica were measured using Tristar 3000 (Messrs. Micromeritics).

The measurement results are as follows.

The specific surface area was 886.2129 to 1,260 m²/g, the pore volume was 1.16 to 1.21 cm³/g, and the pore size was 3.45 to 4.8427 nm.

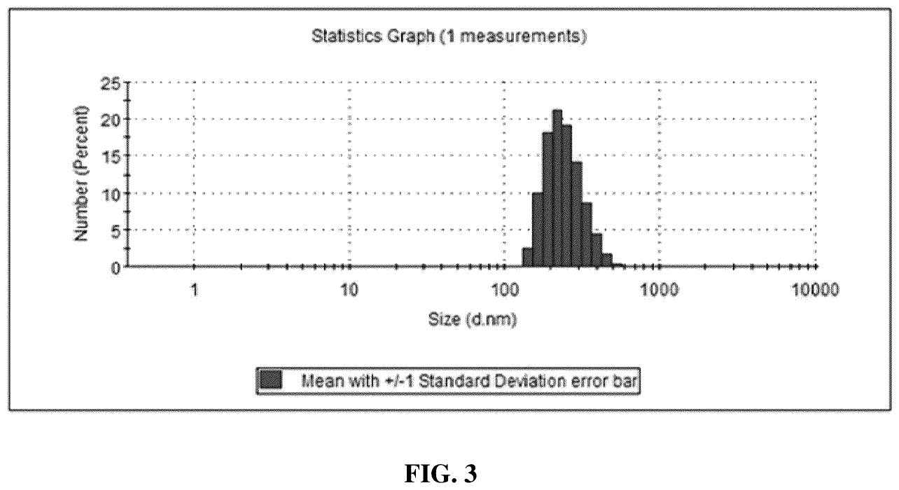

In addition, as shown in FIG. 3, it was found that the average diameter of the particles was 269.1653 nm as measured by dynamic light scattering method, indicating that the particles were distributed in the range of 140 to 550 nm.

### Experimental Example 4

### Evaluation of Ability to Adsorb and Decompose MB

The mesoporous silica of Example 1 was evaluated for its ability to adsorb and decompose methylene blue (MB). Performance evaluation was conducted using P25, known as a conventional photocatalyst, as a comparative example.

The experiment was a photolysis-related experiment and was performed using a stirrer at 150 rpm. A stock solution of methylene blue was prepared by dissolving analytical grade MB in deionized water. A fixed amount (20 mg) of the mesoporous silica or P25 was added to 100 ml of a solution containing 10 ppm of MB, and the mixture was magnetically stirred in a dark room for 30 minutes to obtain adsorption-desorption balance, and then the Xe lamp (20 cm distance, 300 W output) was turned on. The concentration of MB in the solution was analyzed at 10-minute intervals using a UV/Visble 1901 spectrophotometer at a wavelength of 668 nm. The concentration of MB was calculated as follows. Lambert-Beer's law. The photocatalytic efficiency was calculated using the formula n (100%)=C/C0×100%=A/A0×100%, where C0 is the concentration before reaction and C is the concentration obtained.

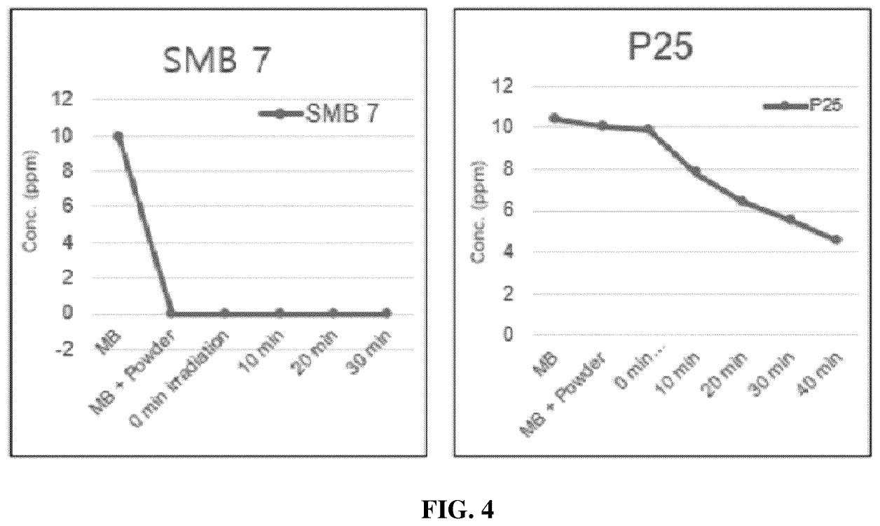

The experimental results are shown in Table 4 below and FIG. 4.

TABLE 4

| | | Example 1 | Comparative Example |
|---|---|---|---|
| No. | Sample | (SMB 7, Conc.) | (P25, Conc.) |
| 1 | MB | 9.91786 | 10.4063 |
| 2 | MB + powder | −0.26345 | 9.99968 |
| 3 | 0 min, irradiation | −0.16858 | 9.85909 |
| 4 | 10 min | −0.3083 | 7.76923 |
| 5 | 20 min | −0.30376 | 6.43407 |
| 6 | 30 min | −0.31139 | 5.52551 |
| 7 | 40 min | −0.26287 | 4.54027 |

(Unit: ppm)

Referring to Table 4 above, it can be seen that, when only methylene blue was included (No. 1), there was no significant difference in concentration, but a significant difference in the MB adsorption and decomposition effect appeared starting immediately after mixing methylene blue and mesoporous silica or mixing methylene blue and P25. P25 is a photocatalyst, and it can be found that the concentration of methylene blue gradually decreased after the mixture of P25 and methylene blue was irradiated with light, but the mesoporous silica of the present invention exhibited excellent effects of adsorbing and decomposing methylene blue even without special treatment.

Based on the above experimental results, it can be confirmed that the mesoporous silica of the present invention exhibits excellent effects of adsorbing and decomposing external contaminants in addition to methylene blue.

### Production Example 2: Production of Spherical Mesoporous Silica in which Hydrophobic Side Chain Protrudes Externally

2.84 g of the mesoporous silica produced in Production Example 1 was dispersed in 100 ml of ethanol, and a solution of 2.84 g (0.1 mol/g) of stearic acid (MW: 284.48) in 100 ml of ethanol was added slowly thereto.

The mixture was vigorously stirred for 3 hours, and the synthesized mesoporous silica was separated by centrifugation and washed 2 or 3 times with alcohol. The centrifugation and washing process was repeated. The washed mesoporous silica was dried in an oven at 80° C. for 12 hours. The yield was 5.65 g.

### Experimental Example 4

### Water Repellency Evaluation

In order to evaluate the water-repellent effect of the mesoporous silica of Production Example 2, a coating agent was applied to one side of a cotton fabric, and the coating agent was adhesion-coated with the mesoporous silica of Production Example 2.

Thereafter, a water drop was dropped on the surface to which the mesoporous silica has been applied, and it was checked whether the shape of the water drop was maintained.

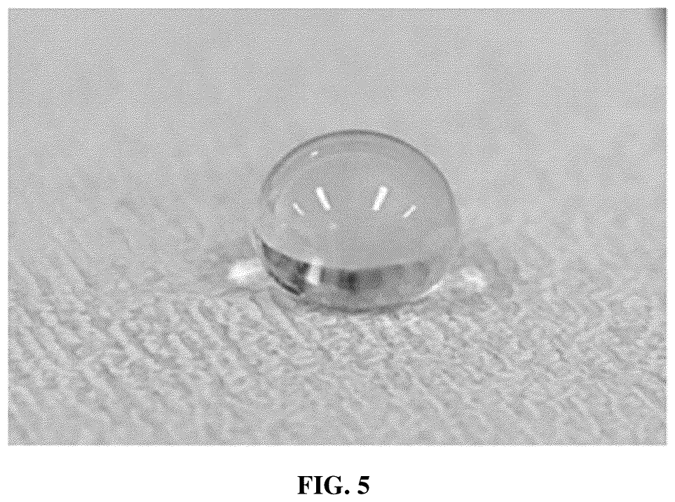

The experimental results are shown in FIG. 5. As shown in FIG. 5, it can be seen that the water drop maintained its shape on the fabric, indicating that the mesoporous silica exhibited a water repellent effect.

In addition, in order to more clearly confirm the hydrophobic property of the hydrophobic side chain, the mesoporous silica of Production Example 2 was added to and mixed with a mixture of nucleic acid and water, and it was checked whether the mixture was separated into layers.

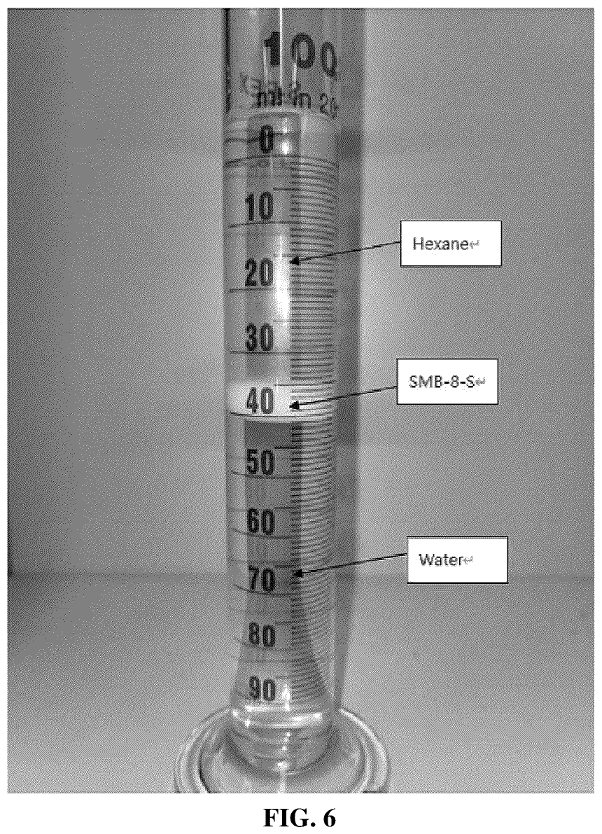

The experimental results are shown in FIG. 6. Referring to FIG. 6, it can be seen that water is located at the bottom, nucleic acid is located at the top, and the mesoporous silica of the present invention is located at the boundary between water and nucleic acid.

### Production Example 3: Production of Spherical Mesoporous Silica in which Hydrophobic Side Chain Protrudes Externally

2.84 g of the mesoporous silica produced in Production Example 1 was dispersed in 100 ml of ethanol, and a solution of 1.85 g (0.1 mol/g) of laurylamine (MW: 185.35) in 100 ml of ethanol was added slowly thereto.

The mixture was vigorously stirred for 3 hours, and the synthesized mesoporous silica was separated by centrifugation and washed 2 or 3 times with alcohol. The centrifugation and washing process was repeated. The washed mesoporous silica was dried in an oven at 80° C. for 12 hours. The yield was 5.65 g.

### Experimental Example 5

### Water Repellency Evaluation

In order to evaluate the water-repellent effect of the mesoporous silica of Production Example 3, a coating agent was applied to one side of a cotton fabric, and the coating agent was adhesion-coated with the mesoporous silica of Production Example 3.

Thereafter, a water drop was dropped on the surface to which the mesoporous silica has been applied, and it was checked whether the shape of the water drop was maintained.

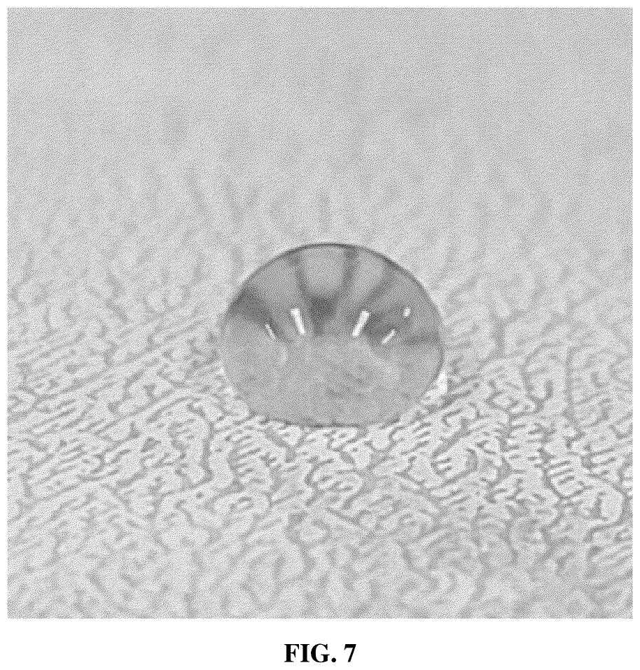

The experimental results are shown in FIG. 7. As shown in FIG. 7, it can be seen that the water drop maintained its shape on the fabric, indicating that the mesoporous silica exhibited a water repellent effect.

In addition, in order to more clearly confirm the hydrophobic property of the hydrophobic side chain, the mesoporous silica of Production Example 3 was added to and mixed with a mixture of nucleic acid and water, and it was checked whether the mixture was separated into layers.

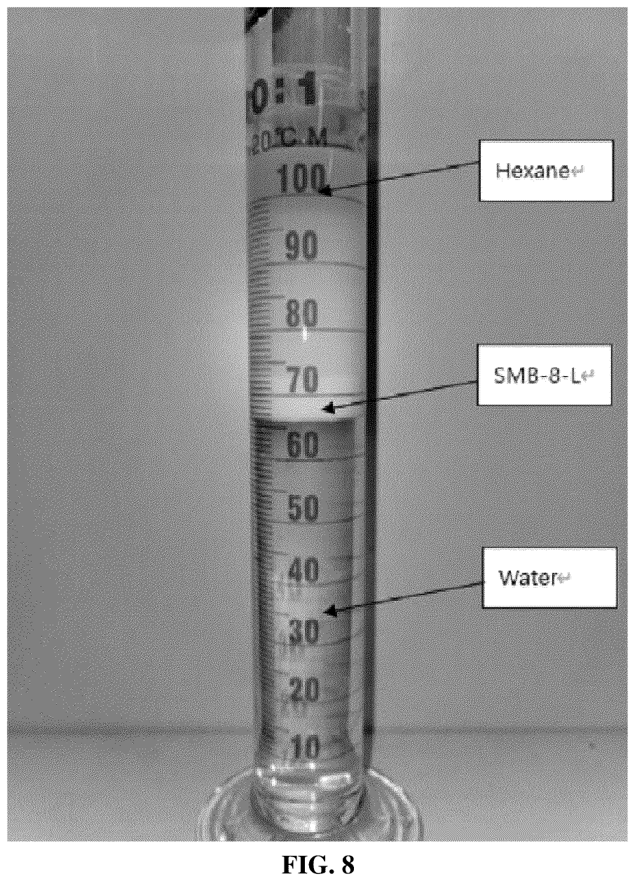

The experimental results are shown in FIG. 8. Referring to FIG. 8, it can be seen that water is located at the bottom, nucleic acid is located at the top, and the mesoporous silica of the present invention is located at the boundary between water and nucleic acid.

Although the preferred embodiments of the present invention have been described in detail above, the scope of the present invention is not limited thereto, and various modifications and improvements can be made by those skilled in the art without departing from the basic concept of the present invention as defined in the following claims, and also fall within the scope of the present invention.

### INDUSTRIAL APPLICABILITY

The present invention relates to mesoporous silica containing zinc oxide and a production method therefor, and specifically, to mesoporous silica wherein a plurality of mesopores are formed in perfectly spherical silica and zinc oxide is bound to the inside of the mesopores, and a production method therefor.

1. Mesoporous silica containing zinc oxide, which is spherical mesoporous silica, wherein an inside of the mesoporous silica contains a plurality of mesopores, zinc ions are bound to the mesopores to form zincosilicate, and zinc oxide is bound to the zincosilicate.

2. The mesoporous silica according to claim 1, wherein fine grooves derived from the internal mesopores are formed on a surface of the mesoporous silica.

3. The mesoporous silica according to claim 1, wherein the zinc oxide is bound to a ligand compound containing a hydrophobic side chain, and the hydrophobic side chain of the ligand compound protrudes to an outside of the mesoporous silica.

4. The mesoporous silica according to claim 1, wherein the spherical mesoporous silica has a specific surface area of 900 to 2,000 m²/g.

5. A method for producing mesoporous silica containing zinc oxide, comprising steps of:
1) adding an alkylamine to a solvent, followed by stirring;
2) preparing a metal ion solution by dissolving a metal compound in the solution containing the alkylamine uniformly dispersed therein;
3) preparing silica-coated complex micelles by adding a silica precursor to the metal ion solution, followed by stirring;
4) producing mesoporous silica by subjecting the silica-coated complex micelles to reduction with a reducing agent; and
5) calcining the mesoporous silica at 500 to 600° C.

6. The method according to claim 5, wherein the metal compound is selected from the group consisting of Zn(NO₃)₂, ZnCl₂, ZnSO₄, Zn(OAc)₂, and mixtures thereof.

7. The method according to claim 5, further comprising a step of allowing a ligand compound containing a hydrophobic side chain to react with the mesoporous silica resulting from the calcining step.

8. The method according to claim 7, wherein the ligand compound is selected from the group consisting of laurylamine, stearic acid, and mixtures thereof.
